(19) United States
(12) Patent Application Publication
(10) Pub. No.: US 2011/0221397 A1
(43) Pub. Date: Sep. 15, 2011

(54) Battery Charging Circuit And Charging Method Thereof

(76) Inventors: Chia-Han Chan, Taipei (TW); Chuan-Rung Wang, Taipei (TW); Shin-Wei Chen, Taipei (TW)

(21) Appl. No.: 12/721,570

(22) Filed: Mar. 11, 2010

(51) Int. Cl. H02J 7/04

(52) U.S. Cl. 320/153

(57) ABSTRACT

A battery charging circuit and a charging method thereof are described hereinafter. The battery charging circuit includes a charging unit connected to an external main power for gaining power to charge a battery, a temperature sensor located beside the charging unit for sensing a temperature of the battery and then sending a corresponding temperature signal out, a main control circuit for receiving the temperature signal sent by the temperature sensor and then transmitting a corresponding power control signal out according to the temperature signal, and a power control circuit connected between the main power and the charging unit for receiving the power control signal transmitted by the main control circuit and then adjusting charging voltage and current for the charging unit according to the power control signal.

### BACKGROUND OF THE INVENTION

1. Field of the Invention

The present invention generally relates to a battery charging circuit and a charging method thereof, and more particularly to a battery charging circuit and a charging method thereof capable of slowing down a battery ageing.

2. The Related Art

With the development of portable electronic products, rechargeable batteries are widely used to supply power for the portable electronic products. When charging the rechargeable battery, it is often desirable that the rechargeable battery is fully charged as soon as possible. As a result, a high temperature is apt to generate on the battery that will seriously affect the battery life. In order to solve the foregoing problem, many methods are used to lower the temperature during charging the battery. One common method is that a charging current is changed according to a cosine-wave for charging the battery. Another method is that the battery is charged firstly by a constant charging current while a charging voltage is gradually increased as the charge process. When a voltage of the battery rises to a certain value, the charging voltage is kept constant for charging the battery while the charging current is gradually reduced according to a power saturation level of the battery. However, the foregoing methods are put into practice by means of pre-setting a process. As a result, it can not be ensured that the battery will be charged as soon as possible without the high temperature on the battery. Furthermore, the pre-set process may be ineffective in certain exceptional circumstances.

### SUMMARY OF THE INVENTION

An object of the present invention is to provide a battery charging circuit and a charging method thereof. The battery charging circuit includes a charging unit connected to an external main power for gaining power to charge a battery, a temperature sensor located beside the charging unit for sensing a temperature of the battery and then sending a corresponding temperature signal out, a main control circuit for receiving the temperature signal sent by the temperature sensor and then transmitting a corresponding power control signal out according to the temperature signal, and a power control circuit connected between the main power and the charging unit for receiving the power control signal transmitted by the main control circuit and then adjusting the charging voltage and current for the charging unit according to the power control signal.

The charging method of the above-mentioned battery charging circuit is described hereinafter. The temperature sensor senses the temperature of the battery and then sends a corresponding temperature signal to the main control circuit at a certain time interval during charging the battery. The main control circuit analyzes the temperature of the battery according to the temperature signal and then sends a corresponding power control signal to the power control circuit when the temperature of the battery rises to a set temperature range. Then the power control circuit adjusts an appropriate charging voltage and current for the charging unit by means of gradually lowering charging voltage and current with the increasing temperature on the battery according to the power control signal.

As described above, the battery charging circuit and the charging method thereof can supply the appropriate charging voltage and current according to the temperature of the battery, so that not only can prevent the damage caused by a high temperature on the battery and slow down the battery ageing, but also can fully charge the battery as soon as possible.

### BRIEF DESCRIPTION OF THE DRAWING

The present invention will be apparent to those skilled in the art by reading the following description, with reference to the attached drawing, in which:

FIG. 1 is a circuitry of a battery charging circuit of the present invention.

### DETAILED DESCRIPTION OF THE PREFERRED EMBODIMENT

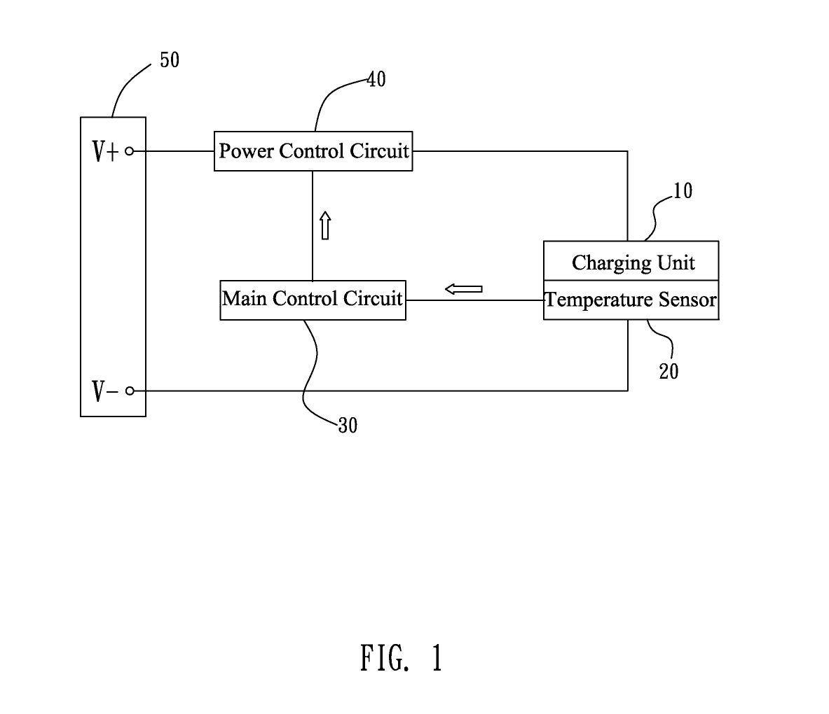

With reference to FIG. 1, a battery charging circuit according to the present invention includes a charging unit 10, a temperature sensor 20, a main control circuit 30 and a power control circuit 40. The charging unit 10 is connected to a main power 50 so as to gain power for charging a battery (not shown). The temperature sensor 20 is located beside the charging unit 10 for sensing a temperature T of the battery and then sending a corresponding temperature signal out. The main control circuit 30 is connected between the temperature sensor 20 and the power control circuit 40 so as to receive the temperature signal from the temperature sensor 20 and then transmit a corresponding power control signal to the power control circuit 40 according to the temperature signal, wherein the power control signal includes a voltage control signal and a current control signal. The power control circuit 40 is further connected between the main power 50 and the charging unit 10 so as to adjust charging voltage and current for the charging unit 10 according to the power control signal.

A charging method of the above-mentioned battery charging circuit is described hereinafter. During charging the battery, the temperature sensor 20 senses the temperature T of the battery and then sends a corresponding temperature signal to the main control circuit 30 at a certain time interval. When the temperature T of the battery is analyzed by the main control circuit 30 to rise to a set temperature range according to the temperature signal, then the main control circuit 30 sends a corresponding power control signal to the power control circuit 40, wherein the power control signal includes a voltage control signal and a current control signal. The power control circuit 40 receives the power control signal and then adjusts an appropriate charging voltage and current for the charging unit 10 according to the voltage control signal and the current control signal respectively, wherein the appropriate charging voltage is represented with V=V1*(1−N), and the appropriate charging current is represented with I=I1*(1−M), where N and M values are listed in the table below, V1 and I1 are respectively a rated charging voltage and a rated charging current.

| T (° C.) | 30 < T ≦ 35 | 35 < T ≦ 40 | 40 < T ≦ 45 | 45 < T ≦ 50 | 50 < T ≦ 55 | 55 < T ≦ 60 | 60 < T |
|---|---|---|---|---|---|---|---|
| N | 2% | 3% | 4% | 5% | 6% | 7% | 8% |
| M | 10% | 20% | 30% | 40% | 50% | 60% | 70% |

As described above, the battery charging circuit and method of the present invention can supply the appropriate charging voltage V and current I according to the temperature T of the battery, so that not only can prevent the damage caused by a high temperature on the battery and slow down the battery ageing, but also can fully charge the battery as soon as possible.

What is claimed is:

1. A battery charging circuit, comprising:
a charging unit connected to an external main power for gaining power to charge a battery;
a temperature sensor located beside the charging unit for sensing a temperature of the battery and then sending a corresponding temperature signal out;
a main control circuit for receiving the temperature signal sent by the temperature sensor and then transmitting a corresponding power control signal out according to the temperature signal; and
a power control circuit connected between the main power and the charging unit for receiving the power control signal transmitted by the main control circuit and then adjusting charging voltage and current for the charging unit according to the power control signal.

2. A charging method of the above-mentioned battery charging circuit, comprising the steps:
the temperature sensor sensing the temperature of the battery and then sending a corresponding temperature signal to the main control circuit at a certain time interval during charging the battery;
the main control circuit analyzing the temperature of the battery according to the temperature signal and then sending a corresponding power control signal to the power control circuit when the temperature of the battery rises to a set temperature range; and
the power control circuit adjusting an appropriate charging voltage and current for the charging unit by means of gradually lowering charging voltage and current with the increasing temperature on the battery according to the power control signal.

3. The charging method as claimed in claim 2, wherein the appropriate charging voltage is represented with V=V1*(1−N) and the appropriate charging current is represented with I=I1*(1−M), where N and M values are listed in the table below, V1 and I1 are respectively a rated charging voltage and a rated charging current.

| T (° C.) | 30 < T ≦ 35 | 35 < T ≦ 40 | 40 < T ≦ 45 | 45 < T ≦ 50 | 50 < T ≦ 55 | 55 < T ≦ 60 | 60 < T |
|---|---|---|---|---|---|---|---|
| N | 2% | 3% | 4% | 5% | 6% | 7% | 8% |
| M | 10% | 20% | 30% | 40% | 50% | 60% | 70% |
